(19) United States
(12) Patent Application Publication
(10) Pub. No.: US 2012/0073843 A1
(43) Pub. Date: Mar. 29, 2012

(54) SUSPENSION DEVICE FOR A WORK VEHICLE

(76) Inventor: Kazuki Kure, Osaka (JP)

(21) Appl. No.: 13/375,268

(22) PCT Filed: Jun. 3, 2010
(86) PCT No.: PCT/JP2010/059424

§ 371 Date: Nov. 30, 2011

(30) Foreign Application Priority Data
Jun. 24, 2009 (JP) 2009-149657

(51) Int. Cl. A01B 63/10; A01B 63/00

(52) U.S. Cl. 172/407; 172/395

(57) ABSTRACT

A suspension device for a work vehicle is capable of not only providing improved ride quality during nonoperational traveling such as on-site movement over uneven terrain, but also ensuring stable driving power during operational traveling such as an excavation operation on uneven terrain. The suspension device 60 has an equalizer bar 61 for coupling undercarriages 4, 4′ provided on both sides, respectively, of a vehicle body 3, the equalizer bar 61 being provided in the vehicle body 3 so as to be freely swingable up and down. This suspension device 60 has pitch angle change cylinders 65 as maximum pitch angle changing mechanism for changing the maximum pitch angle of the equalizer bar 61.

### TECHNICAL FIELD

The present invention relates to a suspension device for a work vehicle, equipped with an equalizer bar.

### BACKGROUND ART

A work vehicle such as a bulldozer is composed of a vehicle body and track-type undercarriages mounted to the right and left sides of the vehicle body. Reference is made to the schematic diagrams of FIGS. 9(a) to 9(d) to hereinafter describe a conventional suspension device which is incorporated into a bulldozer such as described above and has an equalizer bar used for providing stable driving power while the bulldozer is operating on uneven terrain.

In the suspension device shown in FIG. 9(a), the front parts of the left and right undercarriages 4, 4′ are coupled to each other by an equalizer bar 61. The central part of the equalizer bar 61 is coupled to the vehicle body (not shown) by a pin having a horizontally extending pivotal axis such that the equalizer bar 61 is freely swingable about the pin, supporting the vehicle body.

The rear parts of the left and right undercarriages 4, 4′ are supported by pivotal shafts 35 respectively, the pivotal shafts 35 projecting to the right and left respectively from the vehicle body (not shown). The undercarriages 4, 4′ are swingable up and down about the pivotal shafts 35, respectively.

The suspension device having the equalizer bar 61 of this type is disclosed, for example, in Patent Literature 1.

### Citation List

### Patent Literature

Patent Literature 1: JP-A-2001-158386

Next, the operation of the above-described suspension device will be explained. The following explanation describes, as one example, the behavior of the left undercarriage 4 when it climbs over an obstacle M such as a small mound or rock during reverse travel of the bulldozer.

As shown in FIG. 9(a), if the left undercarriage 4 bumps against the obstacle M while the bulldozer is traveling backward, the left undercarriage 4 receives an upward thrust load from the obstacle M.

After receiving an upward thrust load from the obstacle M, the rear part of the left undercarriage 4 is lifted up from the ground as shown in FIG. 9(b).

When the left undercarriage 4 runs onto the obstacle M, the rear part of the left undercarriage 4 is lifted up from the ground to a relatively higher position, as shown in FIGS. 9(b) and 9(c).

Then, the rear part of the left undercarriage 4 drops onto the ground at a breath at the time that the left undercarriage 4 has ridden over the obstacle M, as shown in FIG. 9(d).

As illustrated in FIGS. 9(b) to 9(d), the left undercarriage 4 suddenly drops after its rear part is once lifted up high from the ground when climbing over the obstacle M. On the other hand, the right undercarriage 4′ is kept in contact with the ground in a good condition, irrespective of the movement of the left undercarriage 4, owing to the balance function of the equalizer bar 61.

According to the suspension device having the equalizer bar 61, even if either one of the undercarriages 4 rides onto the obstacle M during digging operation on uneven terrain, the other undercarriage 4 is kept in a good contact condition with respect to the ground. Therefore, stable driving power can be ensured and, in consequence, stable digging operation can be performed on uneven terrain.

However, the above-described conventional suspension device has revealed the following problem. When traveling over uneven terrain without performing operation such as during on-site movement, if either one of the undercarriages 4 climbs over the obstacle M, the part which has bumped against the obstacle M is once lifted up high from the ground and then drops onto the ground at a breath (see FIGS. 9(a) to 9(d)). This causes significant impact shock at the time of the drop of the undercarriage, which results in an uncomfortable ride during nonoperational traveling.

### SUMMARY OF INVENTION

### Problems to be Solved by the Invention

The invention is directed to overcoming the foregoing problem and a primary object of the invention is therefore to provide a suspension device for a work vehicle, the device being capable of providing improved ride quality to the vehicle operator during nonoperational traveling such as on-site movement over uneven terrain while ensuring stable driving power during operational traveling such as digging operation on uneven terrain.

### Means of Solving the Problems

The above object can be accomplished by a suspension device for a work vehicle according to the invention which has an equalizer bar for coupling undercarriages provided on both sides, respectively, of a vehicle body, the equalizer bar being axially supported by a horizontal pivotal axis so as to be freely swingable, the device comprising: maximum pitch angle changing means for changing the maximum pitch angle of the equalizer bar (First Invention). The maximum pitch angle of the equalizer bar stated herein is the angle that corresponds to one half the amplitude between the highest and lowest positions which the equalizer bar can take when pitching about a pin that serves as its pivotal axis.

In a preferable form of the invention, the vehicle body has right and left beams which are hollow in section and are laterally aligned with a specified spacing therebetween, extending in a front-back direction, and the maximum pitch angle changing means is constituted by hydraulic cylinders provided in the beams respectively (Second Invention).

In a preferable form of the invention, the suspension device further comprises determining means for determining whether or not digging operation is performed and controller means for controlling the maximum pitch angle changing means, and the controller means controls the maximum pitch angle changing means based on a result of the determination made by the determining means (Third Invention).

In a preferable form of the invention, the suspension device further comprises a tilt angle sensor for detecting the roll angle of the vehicle, and the controller means controls the maximum pitch angle changing means based on a result of the detection made by the tilt angle sensor, if the determining means determines that digging operation is not performed (Fourth Embodiment). The roll angle of the vehicle stated herein is the pivotal angle of the vehicle about a virtual axis that extends in a front-back direction passing through the center of gravity of the vehicle. It is substantially the same as the tilt angle of the vehicle in lateral directions.

### ADVANTAGEOUS EFFECTS OF INVENTION

According to the invention, the equalizer bar can be locked by the maximum pitch angle changing means so that in cases where either one of the undercarriages rides over an obstacle, the fore parts of both undercarriages with respect to a traveling direction alternately drop onto the ground after simultaneously lifted up from the ground and then the rear parts of both undercarriages with respect to the traveling direction are allowed to land on the ground. More specifically, during nonoperational traveling, the equalizer bar is locked by operating the maximum pitch angle changing means whereby the impact of a drop occurring when either one of the undercarriages rides over an obstacle is not received at one time but received in a plurality of occasions. As a result, the invention can provide ride quality markedly improved over the conventional device during nonoperational traveling.

In addition, according to the invention, the maximum pitch angle of the equalizer bar is set to a specified angle θ (>0°) during operational traveling such as when digging operation is performed on uneven terrain. The setting of the maximum pitch angle of the equalizer bar to the specified angle θ has the following advantage: Even if either one of the undercarriages is lifted up from the ground on occasions when the undercarriage runs onto an obstacle, the other undercarriage can be kept in contact with the ground in a good condition owing to the balance function of the equalizer bar. Therefore, stable driving power can be ensured even when the vehicle climbs over an obstacle during digging operation on uneven terrain so that stable digging operation on uneven terrain becomes possible.

### BRIEF DESCRIPTION OF DRAWINGS

FIG. 1 is an overall side view of a bulldozer to which a suspension device according to one embodiment of the invention is mounted.

FIG. 2 is a schematic structural explanatory view of a power train.

FIG. 3 is a schematic structural explanatory view showing a coupling part between a vehicle body frame and each track frame.

FIG. 4 shows cross-sectional views taken along line A-A of FIG. 3, wherein FIG. 4(a) shows a state view when the maximum pitch angle of an equalizer bar is 7°. FIG. 4(b) shows a state view when the maximum pitch angle of the equalizer bar is 4°, and FIG. 4(c) shows a state view when the maximum pitch angle of the equalizer bar is 0°.

FIG. 5 is a schematic structural view of an electronic hydraulic control system of the bulldozer.

FIG. 6 is a hydraulic pump oil discharge rate control map.

FIG. 7 is a flow chart illustrating a logic for a maximum pitch angle changing program for the equalizer bar.

FIG. 8 shows pattern diagrams illustrating the behavior of a left undercarriage when it climbs over an obstacle with the equalizer bar being locked during reverse travel.

FIG. 9 shows pattern diagrams illustrating the behavior of the left undercarriage when it climbs over an obstacle with the equalizer bar being kept in a swingable condition during reverse travel.

FIG. 10 shows graphs showing changes in the roll angle of the bulldozer, wherein FIG. 10(a) shows a graph when the maximum pitch angle of the equalizer bar is 7°, and FIG. 10(b) shows a graph when the maximum pitch angle of the equalizer bar is 0°.

FIG. 11 is a flow chart illustrating an alternative logic (1) for the maximum pitch angle changing program for the equalizer bar.

FIG. 12 is a flow chart illustrating another alternative logic (2) for the maximum pitch angle changing program for the equalizer bar.

### BEST MODE FOR CARRYING OUT INVENTION

Referring now to the accompanying drawings, a suspending device for a work vehicle will be described according to a preferred embodiment of the invention. Although the following embodiment is associated with a case where the invention is applied to a bulldozer that serves as a work vehicle, it is apparent that the invention is not limited to this. When the terms “front-back direction” and “lateral direction” are used herein, it should be understood that these terms are coincident with the front-back and lateral directions as they would appear to the operator sitting on the operator's seat unless otherwise noted.

### (Description of Overall Structure of Bulldozer)

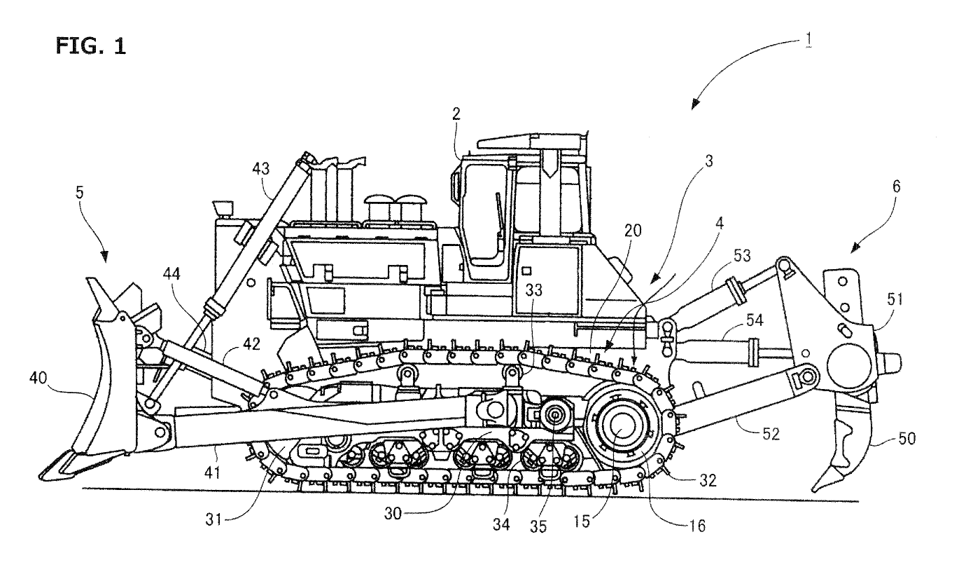

FIG. 1 shows a bulldozer 1 composed of a vehicle body 3 having a cab 2 that constitutes an operator's cab; track-type undercarriages 4, 4′ provided on the left and right sides of the vehicle body 3 (only the left undercarriage is shown); a front work implement (blade implement) 5 disposed in front of the vehicle body 3; and a rear work implement (ripper implement) 6 disposed behind the vehicle body 3.

### (Description of Power Train)

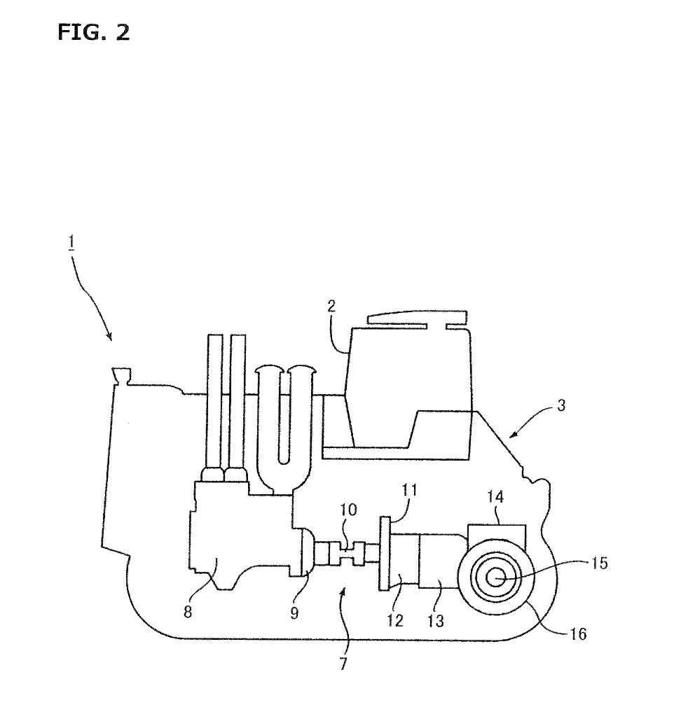

As illustrated in FIG. 2, the vehicle body 3 is mounted on a power train 7. The power train 7 is composed of an engine 8, a damper 9, a universal joint 10, a PTO (Power Take Off) 11, a torque converter 12, a transmission 13, a steering system 14, right and left final reduction gears 15 (only the left final reduction gear is shown) and right and left sprocket wheels 16 (only the left sprocket wheel is shown). These members are arranged in the order named from the front part (the left side of the drawing) to the rear part (the right side of the drawing).

In this power train 7, a rotational power from the engine 8 is transmitted to the right and left sprocket wheels 16 by way of the damper 9, the universal joint 10, the PTO 11, the torque converter 12, the transmission 13, the steering system 14, and the right and left final reduction gears 15.

### (Description of Vehicle Body Frame)

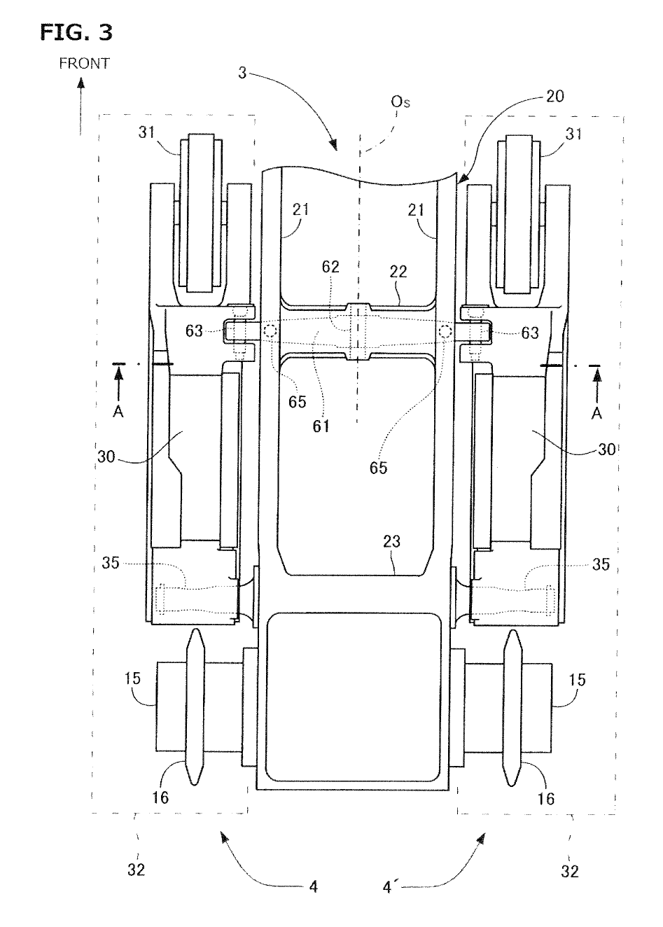

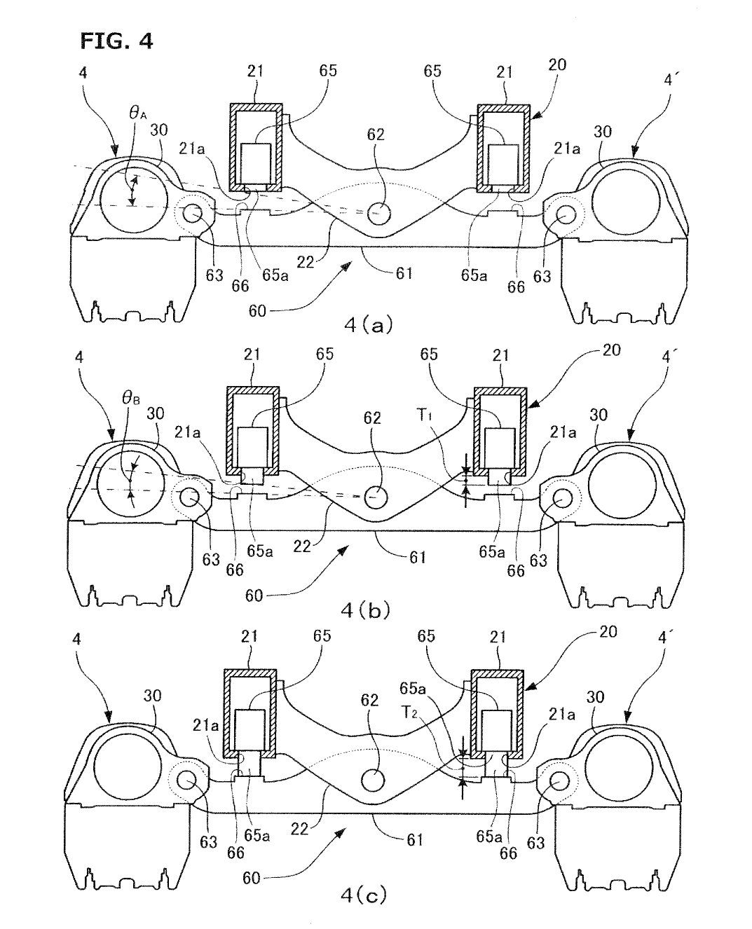

As shown in FIGS. 3 and 4(a), a vehicle body frame 20, which constitutes the framework of the vehicle body 3, includes right and left beams 21 aligned with a specified spacing therebetween in a lateral direction. Each beam 21 has a square tubular shape in section and extends in a front-back direction. The front parts of the right and left beams 21 are connected to each other with the aid of a front cross bar 22. The front cross bar 22 is constituted by a member that is opened downward and has an inverted U shaped cross-section.

The rear parts of the right and left beams 21 are connected to each other with the aid of a rear cross bar 23.

### (Description of Undercarriages)

As shown in FIGS. 1 to 3, the undercarriages 4, 4′ have track frames 30, respectively, that constitute the frameworks thereof. The track frames 30 are located in front of their associated sprocket wheels 16 respectively, extending in a front-back direction. In front of each track frame 30, an idler tumbler 31 is rotatably mounted as an idler wheel. Wounded around the idler tumbler 31 and the sprocket wheel 16 is a track belt 32 that works as an endless track. Provided on the upper surface side of each track frame 30 are a desired number of carrier rollers 33. The carrier rollers 33 support the track belt 32 from the underside thereof, while the track belt 32 moving in a direction from the sprocket wheel 16 to the idler tumbler 31 or in a direction opposite thereto, so that the carrier rollers 33 function to prevent hanging of the track belt 32 due to its own weight and meandering of the track belt 32. Provided on the lower surface side of each track frame 30 is a desired number of track rollers 34. The track rollers 34 function to dispersedly transmit the weight of the vehicle body to the track belt 32 and prevent meandering of the track belt 32.

In each of the undercarriages 4, 4′, the rear part of the track frame 30 is supported by a pivotal shaft 35. Each of the pivotal shaft 35 has an axis that horizontally extends in a lateral direction and is attached to a side surface of the vehicle body frame 20 so as to project outward. The undercarriages 4, 4′ can freely pitch about their associated pivotal shafts 35 each of which has a horizontal pivotal axis.

### (Description of Blade Implement)

As shown in FIG. 1, the blade implement 5 has a blade 40 located anterior to the vehicle body 3. The blade 40 is used for operations such as digging, earth carrying, banking and ground leveling. The blade 40 is supported at a right angle to a traveling direction of the bulldozer 1 by means of straight frames 41 that are attached to the right and left pair of track frames 30 respectively so as to be freely raiseable, a brace 42 for coupling the left straight frame 41 (that appears on the plane of FIG. 1) to the blade 40, an arm (not shown) and others.

The blade 40 is coupled to the vehicle body frame 20 by blade lift cylinders 43. The blade 40 can be lifted by causing the blade lift cylinders 43 to contract. The blade 40 can be lowered by causing the blade lift cylinders 43 to expand.

The blade 40 is coupled to the right straight frame 41 (that is kept out of sight in FIG. 1) by a blade tilt cylinder 44. By operating the blade tilt cylinder 44, the blade 40 can be inclined (tilting).

### (Description of Ripper Implement)

The ripper implement 6 has a ripper 50 located posterior to the vehicle body 3. The ripper 50 is used for not only digging earth but also crushing rocks, The ripper 50 is detachably mounted to a ripper mounting bracket 51. The ripper mounting bracket 51 and the vehicle body frame 20 are coupled to each other by means of an arm 52, ripper tilt cylinders 53 and ripper lift cylinders 54.

The four elements, that is, the ripper mounting bracket 51, the vehicle body frame 20, the arm 52 and the ripper tilt cylinders 53 constitute a four bar linkage. The ripper 50 can be lifted or lowered without changing its pose relative to the ground by causing the ripper lift cylinders 54 to contract or expand. In addition, the digging angle of the ripper 50 can be corrected through the operation of the ripper tilt cylinders 53 thereby effectively performing digging-up operation by the ripper 50.

### (Description of Suspension Device)

Next, reference is made mainly to FIG. 4 to hereinafter explain a suspension device mounted to the bulldozer 1.

### (Description of Equalizer Bar)

A suspension device 60 has an equalizer bar 61 for coupling the left undercarriage 4 (located on the left hand in FIG. 4) and the right undercarriage 4′ (located on the right hand in FIG. 4) to each other.

The central part of the equalizer bar 61 is coupled to the front cross bar 22 having an inverted U-shaped cross-section by a center pin 62 while being incorporated into the front cross bar 22. The center pin 62 has an axis that horizontally extends in a front-back direction along a vehicle body center line O_{S} (see FIG. 3). The equalizer bar 61 can freely pitch up and down about the center pin 62.

The right and left ends of the equalizer bar 61 are coupled to the front parts of the track frames 30 of the undercarriages 4, 4′ by means of side pins 63, respectively. These side pins 63 are located on the right and left sides of the center pin 62, being parallel to the center pin 62. The undercarriages 4, 4′ can freely pitch up and down about the side pins 63, respectively.

### (Description of Pitch Angle Change Cylinders)

Provided inside the right and left beams 21 of the vehicle body frame 20 are hydraulic cylinders (hereinafter referred to as “pitch angle change cylinders”) 65 for changing the maximum pitch angle of the equalizer bar 61. Each pitch angle change cylinder 65 is located just above a position between the central part of the equalizer bar 61 and an end of the equalizer bar 61. The undersides of the beams 21 are provided with cylinder rod insertion holes 21a respectively which are located at positions facing the upper surface of the equalizer bar 61 such that the cylinder rod insertion holes 21a can receive cylinder rods 65a of the pitch angle change cylinders 65, respectively. The cylinder rods 65a of the pitch angle change cylinders 65 can be freely extended from the undersides of the beams 21 toward the upper surface of the equalizer bar 61 and retracted therefrom through the cylinder rod insertion holes 21a.

The pitch angle change cylinders 65 are not limited to hydraulic cylinders but may be, for example, magnetic fluid cylinders or air cylinders. It should also be noted that the positions where the pitch angle change cylinders 65 are installed are not limited to the inside of the beams 21. As long as the pitch angle change cylinders 65 can be located just above positions between the central part and ends of the equalizer bar 61, they may be placed inside the cross bar 22 or outside the beams 21.

As shown in FIG. 4(a), in cases where the amount of projection of the cylinder rods 65a of the pitch angle change cylinders 65 from the undersides of the beams 21 (this amount is hereinafter referred to as “the amount of projection of the cylinder rods 65a”) is zero, the beams 21 hit against movement stop portions 66 of the equalizer bar 61 respectively, functioning as stoppers. At that time, the maximum pitch angle of the equalizer bar is θ_{A} (e.g., 7°).

As shown in FIG. 4(b), in cases where the amount of projection of the cylinder rods 65a is a specified amount T₁ that is smaller than a maximum amount of projection T₂, the cylinder rods 65a hit against the movement stop portions 66 of the equalizer bar 61 respectively, functioning as stoppers. At that time, the maximum pitch angle of the equalizer bar 61 is limited to θ_{B} (e.g.,) 420 that is smaller than θ_{A}.

As shown in FIG. 4(c), in cases where the pitch angle change cylinders 65 are expanded until the cylinder rods 65a hit against the equalizer bar 61 so that the amount of projection of the cylinder rods 65a becomes equal to the maximum amount of projection T₂, the equalizer bar 61 is locked by the pitch angle change cylinders 65 so that the maximum pitch angle of the equalizer bar 61 becomes θ_{C} (e.g., 0°).

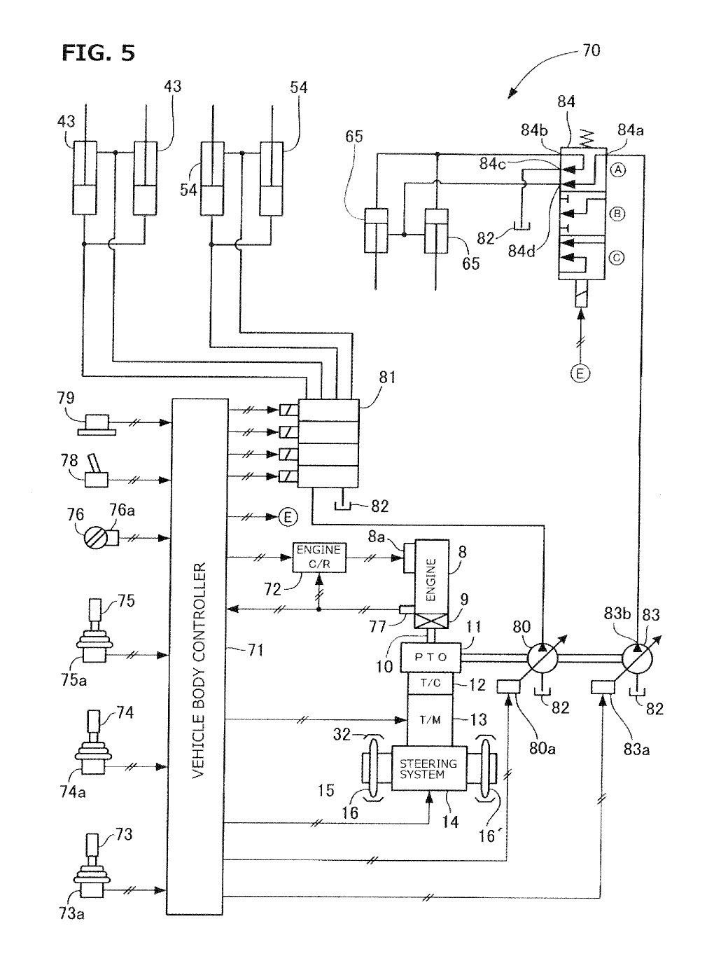

Referring mainly to FIG. 5, an electronic hydraulic control system of the bulldozer 1 will be described below.

### (Description of Vehicle Body Controller and Engine Controller)

FIG. 5 shows an electronic hydraulic control system 70 having a vehicle body controller 71 and an engine controller 72 which are each mainly composed of a microcomputer.

According to specified programs stored in a memory, the vehicle body controller 71 and the engine controller 72 respectively read input signals and various data, execute specified arithmetic operations, and output control signals based on the results of the arithmetic operations.

The vehicle body controller 71 executes a pitch angle change program (described later) for the equalizer bar 61 in response to signals issued from a blade control lever 73, a ripper control lever 74, a travel control lever 75, a fuel dial 76, an engine rotational speed sensor 77, a change-over switch 78, and a tilt angle sensor 79.

The engine controller 72 calculates a fuel injection amount control signal to be released to an electronically-controlled fuel injector 8a provided in the engine 8. The electronically-controlled fuel injector 8a controls the injection amount of fuel in response to the fuel injection amount control signal from the engine controller 72. The rotational speed of the engine 8 is controlled in accordance with the fuel injection amount control signal that is transmitted from the engine controller 72 to the electronically-controlled fuel injector 8a.

### (Description of Hydraulic Circuit for Blade Lift Cylinders)

In the electronic hydraulic control system 70, pressurized oil from a first hydraulic pump 80 driven by the engine 8 is supplied to the head-side oil sacs or bottom-side oil sacs of the blade lift cylinders 43 through a main valve 81.

### (Description of First Hydraulic Pump)

The first hydraulic pump 80 is a variable displacement hydraulic pump in which the discharge rate of oil varies in accordance with the angle of a swash plate. This first hydraulic pump 80 is provided with a first swash plate angle controller 80a. The first swash plate angle controller 80a controls the swash plate angle of the first hydraulic pump 80 in response to a first swash plate angle control signal from the vehicle body controller 71.

### (Description of Blade Control Lever)

The blade control lever 73 is for performing operations for lifting and lowering the blade 40, and the like. The blade control lever 73 is provided with a lever operation detector 73a that outputs a detection signal indicative of the lever control of the blade control lever 73.

### (Description of Blade Lift Operation)

After a detection signal corresponding to the operation for lifting the blade 40 is transmitted from the lever operation detector 73a to the vehicle body controller 71, the vehicle body controller 71 transmits a valve shift signal corresponding to the detection signal to the main valve 81, and the main valve 81 executes the following oil passage switching operation in response to the valve shift signal. More specifically, the main valve 81 supplies pressurized oil from the first hydraulic pump 80 to the head-side oil sacs of the blade lift cylinders 43, while performing an oil passage switching operation such that the oil stored in the bottom-side oil sacs of the blade lift cylinders 43 flows back to a tank 82. This causes contraction of the blade lift cylinders 43 thereby to lift the blade 40.

### (Description of Blade Lowering Operation)

After a detection signal corresponding to the operation for lowering the blade 40 is transmitted from the lever operation detector 73a to the vehicle body controller 71, the vehicle body controller 71 transmits a valve shift signal corresponding to the detection signal to the main valve 81, and the main valve 81 executes the following oil passage switching operation in response to the valve shift signal. More specifically, the main valve 81 supplies pressurized oil from the first hydraulic pump 80 to the bottom-side oil sacs of the blade lift cylinders 43, while performing an oil passage switching operation such that the oil stored in the head-side oil sacs of the blade lift cylinders 43 flows back to the tank 82. This causes expansion of the blade lift cylinders 43 thereby to lower the blade 40.

### (Description of Hydraulic Circuit of Ripper Lift Cylinders)

In the electronic hydraulic control system 70, the pressurized oil from the first hydraulic pump 80 driven by the engine 8 is supplied to the head-side oil sacs or bottom-side oil sacs of the ripper lift cylinders 54 through the main valve 81.

### (Description of Ripper Control Lever)

The ripper control lever 74 is for performing operations for lifting and lowering the ripper 50, and the like. The ripper control lever 74 is provided with a lever operation detector 74a that outputs a detection signal indicative of the lever control of the ripper control lever 74.

### (Description of Ripper Lift Operation)

After a detection signal corresponding to the operation for lifting the ripper 50 is transmitted from the lever operation detector 74a to the vehicle body controller 71, the vehicle body controller 71 transmits a valve shift signal corresponding to the detection signal to the main valve 81, and the main valve 81 executes the following oil passage switching operation in response to the valve shift signal. More specifically, the main valve 81 supplies pressurized oil from the first hydraulic pump 80 to the head-side oil sacs of the ripper lift cylinders 54, while performing oil passage switching operation such that the oil stored in the bottom-side oil sacs of the ripper lift cylinders 54 flows back to the tank 82. This causes contraction of the ripper lift cylinders 54 thereby to lift the ripper 50.

### (Description of Ripper Lowering Operation)

After a detection signal corresponding to the operation for lowering the ripper 50 is transmitted from the lever operation detector 74a to the vehicle body controller 71, the vehicle body controller 71 transmits a valve shift signal corresponding to the detection signal to the main valve 81, and the main valve 81 executes oil passage switching operation in response to the valve shift signal. More specifically, the main valve 81 supplies pressurized oil from the first hydraulic pump 80 to the bottom-side oil sacs of the ripper lift cylinders 54. while performing oil passage switching operation such that the oil stored in the head-side oil sacs of the ripper lift cylinders 54 flows back to the tank 82. This causes expansion of the ripper lift cylinders 54 thereby to lower the ripper 50.

### (Description of Travel Control Lever)

The travel control lever 75 is for controlling the forward and reverse travels and clockwise and counter-clockwise turning of the bulldozer 1, and the like. The travel control lever 75 is provided with a lever operation detector 75a that outputs a detection signal according to the lever control of the travel control lever 75.

### (Description of Forward Travel Control)

Upon receipt of a detection signal indicative of the forward travel of the bulldozer 1 from the lever operation detector 75a, the vehicle body controller 71 transmits a forward gear selection signal to the transmission 13. As a result, a forward gear is selected from the speed gears of the transmission 13 so that the bulldozer 1 travels forward.

### (Description of Reverse Travel Control)

Upon receipt of a detection signal indicative of the reverse travel of the bulldozer 1 from the lever operation detector 75a, the vehicle body controller 71 transmits a reverse gear selection signal to the transmission 13. As a result, a reverse gear is selected from the speed gears of the transmission 13 so that the bulldozer 1 starts to travel backward.

### (Description of Clockwise Turning Control)

Upon receipt of a detection signal indicative of the clockwise turning of the bulldozer 1 from the lever operation detector 75a, the vehicle body controller 71 transmits a clockwise turning selection signal corresponding to the detection signal to the steering system 14. The steering system 14 performs the following operation, for example, during the forward travel. Specifically, the steering system 14 increases the rotational speed of the left sprocket wheel 16 relatively to that of the right sprocket wheel 16′ in response to the clockwise turning signal from the vehicle body controller 71. As a result, the bulldozer 1 starts to turn in a clockwise direction relative to the traveling direction during the forward travel.

### (Description of Counterclockwise Turning Control)

Upon receipt of a detection signal indicative of the counterclockwise turning of the bulldozer 1 from the lever operation detector 75a, the vehicle body controller 71 transmits a counterclockwise turning selection signal corresponding to the detection signal to the steering system 14. The steering system 14 performs the following operation, for example, during the forward travel. Specifically, the steering system 14 increases the rotational speed of the right sprocket wheel 16′ relatively to that of the left sprocket wheel 16, in response to the counterclockwise turning signal from the vehicle body controller 71. As a result, the bulldozer 1 starts to turn in a counterclockwise direction relative to the traveling direction during the forward travel.

### (Description of Fuel Dial)

The fuel dial 76 is for setting the rotational speed of the engine 8. The fuel dial 76 is equipped with a dial control detector 76a for releasing a detection signal in accordance with the dial operation of the fuel dial 76. Based on the detection signal from the dial control detector 76a, the vehicle body controller 71 calculates an engine rotational speed control signal to be released to the engine controller 72.

### (Description of Engine Rotational Speed Sensor)

The engine rotational speed sensor 77 is for detecting the rotational speed of the engine 8. The detection signal of this engine rotational speed sensor 77 is transmitted to the vehicle body controller 71 and the engine controller 72, respectively.

### (Description of Function of Engine Controller)

The engine controller 72 calculates a fuel injection amount control signal by comparison between the present rotational speed of the engine 8 based on the detection signal from the engine rotational speed sensor 77 and a target value for the rotational speed of the engine 8 based on the engine rotational speed control signal from the vehicle body controller 71. The fuel injection amount control signal causes the present rotational speed of the engine 8 to be equal to the target value.

### (Description of Change-Over Switch)

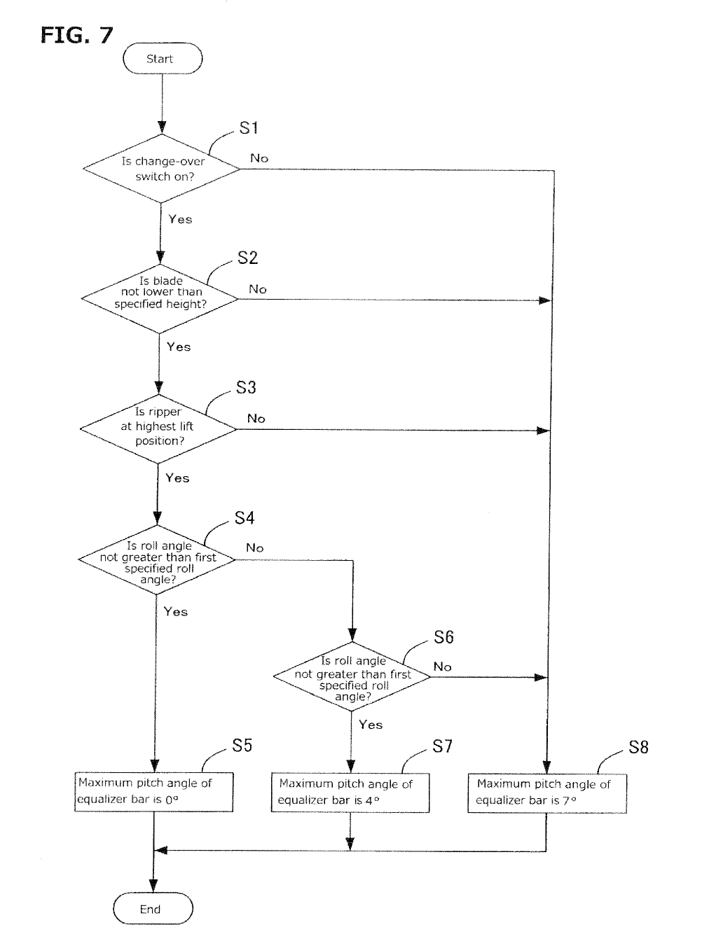

The change-over switch 78 is for selecting control for changing the maximum pitch angle of the equalizer bar 61. After the change-over switch 78 issues an ON signal to the vehicle body controller 71, the vehicle body controller 71 changes the maximum pitch angle of the equalizer bar 61 in accordance with the logic shown in the flow chart of FIG. 7.

### (Description of Tilt Angle Sensor)

The tilt angle sensor 79 is for detecting the tilt angle (roll angle) of the bulldozer 1 in lateral directions. Based on this detection signal of the tilt angle sensor 79, the vehicle body controller 71 calculates the roll angle of the bulldozer 1.

### (Description of Oil Discharge Rate Control for First Hydraulic Pump)

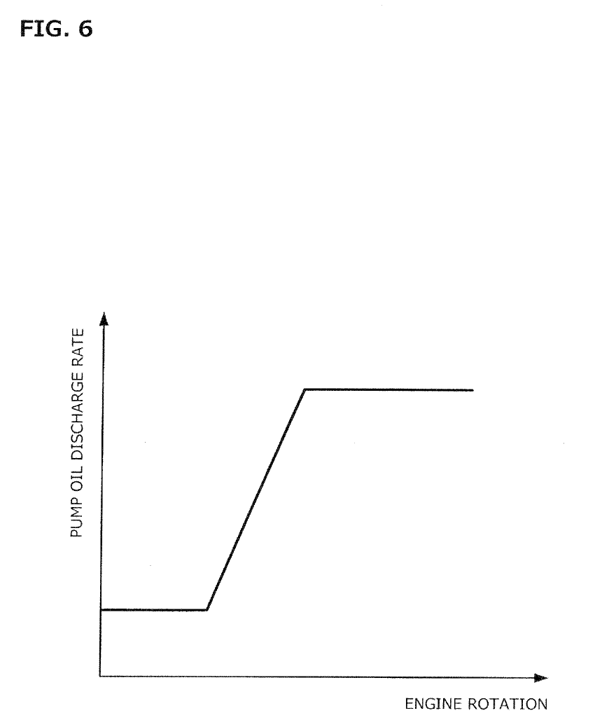

A hydraulic pump oil discharge rate control map such as shown in FIG. 6 is stored in the memory of the vehicle body controller 71. This hydraulic pump oil discharge rate control map specifies the relationship between the oil discharge rate and the rotational speed of the engine 8. The vehicle body controller 71 calculates a first swash plate angle control signal to be output to the first swash plate angle controller 80a, based on the rotational speed of the engine 8 obtained from a detection signal from the engine rotational speed sensor 77 and the hydraulic pump oil discharge rate control map shown in FIG. 6. Then, the vehicle body controller 71 transmits the first swash plate angle control signal obtained from the calculation to the first swash plate angle controller 80a. As a result, the oil discharge rate of the first hydraulic pump 80 is controlled according to the hydraulic pump oil discharge rate control map shown in FIG. 6.

### (Description of Blade Height Detecting Means)

As the vehicle body controller 71 is in charge of controlling the oil discharge rate of the first hydraulic pump 80, it, as a matter of course, acquires the status of the oil discharge rate of the first hydraulic pump 80 on a constant basis. Besides, the vehicle body controller 71 is in charge of controlling the switching of the main valve 81, it, as a matter of course, acquires the status of oil coming into and out of the blade lift cylinders 43 on a constant basis. Therefore, the flow rates of oil entering and leaving the head-side oil sacs and bottom-side oil sacs, respectively, of the blade lift cylinders 43 can be obtained, based on the oil discharge rate of the first hydraulic pump 80 and a detection signal from the lever operation detector 73a provided for the blade control lever 73. The expansion and contraction length of the blade lift cylinders 43 can be obtained from the flow rate of oil coming in and out of the blade lift cylinders 41 In view of the link motion of the blade 40, an unambiguous relationship exists between the expansion and contraction length of the blade lift cylinders 43 and the height of the blade 40 from the ground. Therefore, the vehicle body controller 71 can obtain the height of the blade 40 from the ground, based on the flow rate of oil coming into and out of the blade lift cylinders 43.

### (Description of Ripper Height Detecting Means)

Similarly, based on the oil discharge rate of the first hydraulic pump 80 and a detection signal from the lever operation detector 74a provided for the ripper control lever 74, the flow rate of oil coming into and out of the head-side oil sacs and bottom-side oil sacs, respectively, of the ripper lift cylinders 54 can be obtained. The expansion and contraction length of the ripper lift cylinder 54 can be obtained from the flow rate of oil coming in and out of the ripper lift cylinders 54. In view of the link motion of the ripper 50, an unambiguous relationship exists between the expansion and contraction length of the ripper lift cylinders 54 and the height of the ripper 50 from the ground. Therefore, the vehicle body controller 71 can obtain the height of the ripper 50 from the ground, based on the flow rate of oil coming into and out of the ripper lift cylinders 54.

### (Description of Hydraulic Circuit for Pitch Angle Change Cylinders)

In the electronic hydraulic control system 70, the pressurized oil from a second hydraulic pump 83 driven by the engine 8 is supplied to each of the pitch angle change cylinders 65 through a pitch angle change valve 84.

### (Description of Second Hydraulic Pump)

The second hydraulic pump 83 is a variable displacement hydraulic pump in which the discharge rate of oil varies in accordance with the angle of the swash plate. This second hydraulic pump 83 is equipped with a second swash plate angle controller 83a. The second swash plate angle controller 83a controls the swash plate angle of the second hydraulic pump 83 in response to a second swash plate angle control signal from the vehicle body controller 71.

### (Description of Pitch Angle Change Valve)

The pitch angle change valve 84 has a first port 84a, a second port 84b, a third port 84c and a fourth port 84d. The pitch angle change valve 84 is shifted to three positions, that is, Position A, Position B and Position C in response to a valve change signal from the vehicle body controller 71.

The first port 84a of the pitch angle change valve 84 is connected to a pressurized oil discharge port 83b of the second hydraulic pump 83.

The second port 84b of the pitch angle change valve 84 is connected to the bottom-side oil sacs of the pitch angle change cylinders 65.

The third port 84c and fourth port 84d of the pitch angle change valve 84 are each connected to the tank 82.

When the pitch angle change valve 84 is placed at Position A, the first port 84a is communicated with the fourth port 84d whereas the second port 84b is communicated with the third port 84c.

The establishment of the communication between the first port 84a and the fourth port 84d causes the pressurized oil from the second hydraulic pump 83 to flow back to the tank 82 by way of the first port 84a and the fourth port 84d.

The establishment of the communication between the second port 84b and the third port 84c causes both of the bottom-side oil sacs of the pitch angle change cylinders 65 to be connected to the tank 82 through the second port 84b and the third port 84c so that the oil dwelling in those bottom-side oil sacs flows back to the tank 82 by way of the second port 84b and the third port 84c. As a result, the pitch angle change cylinders 65 contract because of the weight of the equalizer bar 61 imposed thereon when the equalizer bar 61 is in a pitching motion, so that the amount of projection of the cylinder rods 65a becomes zero and the maximum pitch angle of the equalizer bar 61 becomes θ_{A} (7° in this embodiment (see FIG. 4(a)).

When the pitch angle change valve 84 is placed at Position B, the first port 84a is communicated with the fourth port 84d, whereas the second port 84b and the third port 84c are respectively closed.

The establishment of the communication between the first port 84a and the fourth port 84d causes the pressurized oil from the second hydraulic pump 83 to flow back to the tank 82 by way of the first port 84a and the fourth port 84d.

Upon the closing of the second port 84b, the incomings and outgoings of oil with respect to the bottom-side oil sacs of the pitch angle change cylinders 65 are interrupted so that the pitch angle change cylinders 65 do not expand nor contract, being brought into an expansion/contraction interrupted condition (locked condition) (see FIG. 4(b)).

When the pitch angle change valve 84 is placed at Position C, the first port 84a is communicated with the second port 84b, whereas the third port 84c and the fourth port 84d are respectively closed.

The establishment of the communication between the first port 84a and the second port 84b causes the pressurized oil from the second hydraulic pump 83 to be supplied to the bottom-side oil sacs of the pitch angle change cylinders 65 by way of the first port 84a and the second port 84b, As a result, the pitch angle change cylinders 65 expand until the cylinder rods 65a hit against the equalizer bar 61, so that the amount of projection of the cylinder rods 65a becomes T₂, the equalizer bar 61 is locked by the pitch angle change cylinders 65 and the maximum pitch angle of the equalizer bar 61 becomes θ_{C} (e.g., 0°) (see FIG. 4(c)).

That is, Position A is such a valve shift position that when the pitch angle change valve 84 is at Position A, the pitch angle change cylinders 65 contract. Position B is such a valve shift position that when the pitch angle change valve 84 is at Position B, the expansion and contraction of the pitch angle change cylinders 65 is interrupted. Position C is such a valve shift position that when the pitch angle change valve 84 is at Position C, the pitch angle change cylinders 65 expand.

### (Description of Oil Discharge Rate Control for Second Hydraulic Pump)

The vehicle body controller 71 calculates a second swash plate angle control signal to be output to the second swash plate angle controller 83a, based on the rotational speed of the engine 8 obtained from a detection angle of the engine rotational speed sensor 77 and the hydraulic pump oil discharge rate control map shown in FIG. 6. Then, the vehicle body controller 71 transmits the second swash plate angle control signal obtained by the calculation to the second swash plate angle controller 83a. As a result, the oil discharge rate of the second hydraulic pump 83 is controlled according to the hydraulic pump oil discharge rate control map shown in FIG. 6.

### (Description of Cylinder Rod Projection Amount Detecting Means)

As the vehicle body controller 71 is in charge of controlling the oil discharge rate of the second hydraulic pump 83, it, as a matter of course, acquires the status of the oil discharge rate of the second hydraulic pump 83 on a constant basis. Besides, the vehicle body controller 71 is in charge of controlling the shift of the pitch angle change valve 84, it, as a matter of course, acquires the status of oil coming into and out of the pitch angle change cylinders 65 on a constant basis. Therefore, the flow rate of oil coming into and out of the pitch angle change cylinders 65 can be obtained based on the oil discharge rate of the second hydraulic pump 83 and based on the shift operation for the pitch angle change valve 84. In addition, the expansion and contraction length of the pitch angle change cylinders 65 can be obtained from the amount of oil coming into and out of the pitch angle change cylinders 65. An unambiguous relationship exists between the expansion and contraction length of the pitch angle change cylinders 65 and the amount of projection of the cylinder rods 65a. Therefore, the vehicle body controller 71 can obtain the amount of projection of cylinder rods 65a based on the flow rate of oil coming into and out of the pitch angle change cylinders 65.

### (Description of Cylinder Rod Projection Amount Control)

The following operation is performed when the amount of projection of the cylinder rods 65a is a specified projection amount T₁.

Specifically, the vehicle body controller 71 calculates a valve shift signal for making the present amount of projection of the cylinder rods 65a equal to a target value, based on the comparison between the present amount of projection of the cylinder rods 65a obtained from the amount of oil coming into and out of the pitch angle change cylinders 65 and the target value (T₁) for the projection amount of the cylinder rods 65a. After the pitch angle change valve 84 receives the valve shift signal obtained by the above arithmetic operation, the operation for shifting the pitch angle change valve 84 from Position C to Position B or Position A to Position B is controlled, so that the flow rate of oil coming into and out of the pitch angle change cylinders 65 is controlled thereby to make the present amount of projection of the cylinder rods 65a close to the target value (T₁). After the present amount of projection of the cylinder rods 65a has reached the target value (T₁), the pitch angle change valve 84 is considered to have been shifted to Position B and therefore, this shift operation is completed. The amount of projection of the cylinder rods 65a is thus made to be equal to T₁, so that the maximum pitch angle of the equalizer bar 61 becomes θ_{B} (4° in this embodiment).

### (Description of Maximum Pitch Angle Change Program)

Reference is made mainly to the flow chart of FIG. 7 to describe the processing content of the maximum pitch angle change program for the equalizer bar 61 executed by the vehicle body controller 71 of the bulldozer 1 having the above-described structure.

Note that the symbol “S” in FIG. 7 designates a “step”.

### (Processing Content of Step S1)

At Step S1, it is determined based on an ON/OFF signal from the change-over switch 78 whether the maximum pitch angle change control for the equalizer bar 61 has been selected.

### (Processing Content of Step S2)

If it is determined, upon receipt of an ON signal from the change-over switch 78 at Step S1, that the maximum pitch angle change control for the equalizer bar 61 has been selected, a check is then made to determine whether or not the height of the blade 40 from the ground is not lower than a specified height H_{B} (e.g., 850 mm).

Specifically, the height of the blade 40 from the ground is obtained based on the flow rate of oil coming into and out of the blade lift cylinder 43 and then, a check is made to determine whether the obtained height value is not lower than the specified height H_{B}.

Generally, the blade 40 is lifted to the specified height H_{B} or more during nonoperational traveling. Therefore, the specified height H_{B} is used as a threshold value for the determination based on the height of the blade 40 on whether nonoperational traveling or operational traveling is carried out. And, if the value of the height of the blade 40 obtained by the arithmetic operation is not lower than the specified height H_{B}, it is determined that the bulldozer simply travels for relocation from one point to another in a job site without performing digging operation.

### (Processing Content of Step S3)

If it is determined at Step S2 that the height of the blade 40 from the ground is not lower than the specified height H_{B}, a check is then made to determine whether the height of the ripper 50 from the ground is equal to a specified height H_{L} that represents the highest lift position of the ripper 50.

Specifically, the height of the ripper 50 from the ground is obtained based on the flow rate of oil coming into and out of the ripper lift cylinders 54 and then, a check is made to determine whether the obtained height value is equal to the specified height H_{L}.

Generally, the ripper 50 is positioned at the highest lift position during nonoperational traveling. Therefore, the specified height H_{L} indicative of the highest lift position is used as a threshold for the determination, based on the height of the ripper 50, on whether nonoperational traveling or operational traveling is carried out. And, if the height value of the ripper 50 obtained by the arithmetic operation is equal to the specified height H_{L}, it is determined that the bulldozer simply travels for relocation from one point to another in a job site without performing digging operation.

### (Processing Content of Step S4)

If it is determined at Step S3 that the ripper 50 is at the highest lift position, a check is then made to determine whether the tilt angle of the bulldozer 1 in a lateral direction, that is, the roll angle of the bulldozer 1 is not greater than a first specified roll angle θ_{R1} (e.g., 10°).

Specifically, the roll angle of the bulldozer 1 is obtained based on a detection signal from the tilt angle sensor 79 and then, a check is made to determine whether the value of the roll angle thus obtained is not greater than the first specified roll angle θ_{R1}.

### (Processing Content of Step S5)

If it is determined at Step S4 that the roll angle of the bulldozer 1 is not greater than the first specified roll angle θ_{R1}, a valve switch signal instructing a shift of the pitch angle change valve 84 to Position C is transmitted to the pitch angle change valve 84 so that the pitch angle change valve 84 is shifted to Position C. As a result, the pitch angle change cylinders 65 expand until the cylinder rods 65a hit against the equalizer bar 61, so that the amount of projection of the cylinder rods 65a becomes T₂, the equalizer bar 61 is locked by the pitch angle change cylinders 65 and the maximum pitch angle of the equalizer bar 61 becomes 0° (see FIG. 4(c)).

### (Processing Content of Step S6)

If it is determined at Step 84 that the roll angle of the bulldozer 1 is greater than the first specified roll angle θ_{R1}, a check is then made to determine whether the roll angle of the bulldozer 1 is not greater than a second specified roll angle θ_{R2} (e.g., 15°).

Specifically, the roll angle of the bulldozer 1 is obtained based on a detection signal from the tilt angle sensor 79 and then, a check is made to determine whether the value of the roll angle thus obtained is not greater than the second specified roll angle θ_{R2}.

### (Processing Content of Step S7)

If it is determined at Step S6 that the roll angle of the bulldozer 1 is not greater than the second specified roll angle θ_{R2}, the present amount of projection of the cylinder rods 65a obtained from the flow rate of oil coming into and out of the pitch angle change cylinders 65 is compared with the target value (T₁) for the amount of projection of the cylinder rods 65a. Subsequently, a valve shift signal for making the present amount of projection of the cylinder rods 65a equal to the target value is calculated, and the valve shift signal obtained from this arithmetic operation is transmitted to the pitch angle change valve 84. As a result, the operation for shifting the pitch angle change valve 84 from Position C to Position B or from Position A to Position B is controlled, so that the flow rate of oil coming into and out of the pitch angle change cylinders 65 is controlled thereby to make the present amount of projection of the cylinder rods 65a close to the target value (T₁). After the present amount of projection of the cylinder rods 65a has reached the target value (T₁), the pitch angle change valve 84 is considered to have been shifted to Position B and this shift operation is completed. The present amount of projection of the cylinder rods 65a has reached the target value (T₁) in this way, so that the maximum pitch angle of the equalizer bar 61 becomes θ_{B} (4° in this embodiment) (see FIG. 4(b)).

The processing of Step S8 is executed in any of the following cases (1) to (4).

Case (1): It is determined at Step S1 upon receipt of an OFF signal from the change-over switch 78 that the maximum pitch angle change control for the equalizer bar 61 has not been selected.

Case (2): It is determined at Step S2 that the height of the blade 40 from the ground is lower than the specified height H_{B} (850 mm in this embodiment).

Case (3): It is determined at Step S3 that the height of the ripper 50 from the ground is lower than the specified height H_{L} indicative of the highest lift position of the ripper 50.

Case (4): It is determined at Step S6 that the roll angle of the bulldozer 1 is greater than the second specified roll angle θ_{R2} (15° in this embodiment).

### (Processing Content of Step S8)

At Step S8, a valve shift signal instructing a shift of the pitch angle change valve 84 to Position A is transmitted to the pitch angle change valve 84 so that the pitch angle change valve 84 is shifted to Position A. As a result, the bottom-side oil sacs of the pitch angle change cylinders 65 are both connected to the tank 82 through the second port 84b and the third port 84c so that the oil dwelling inside the bottom-side oil sacs flows back to the tank 82 by way of the second port 84b and the third port 84c. After the discharged oil of the second hydraulic pump 83 has flowed into the head sides of the cylinders 65, the pitch angle change cylinders 65 contract with the amount of projection of the cylinder rods 65a becoming zero and the pitch angle of the equalizer bar 61 becoming θ_{A} (7° in this embodiment) (see FIG. 4(a)).

In this embodiment, after it is determined that nonoperational traveling such as on-site movement on uneven terrain is performed (“Yes” at both Steps S2 and S3) and that side slipping is unlikely to occur even during traveling on a slope (“Yes” at Step S4), the equalizer bar 61 is locked by the pitch angle change cylinders 65 and the maximum pitch angle of the equalizer bar 61 becomes 0° (Step S5). That is, the pitching movement of the equalizer bar 61 is restricted so that the equalizer bar 61 is brought into a locked condition.

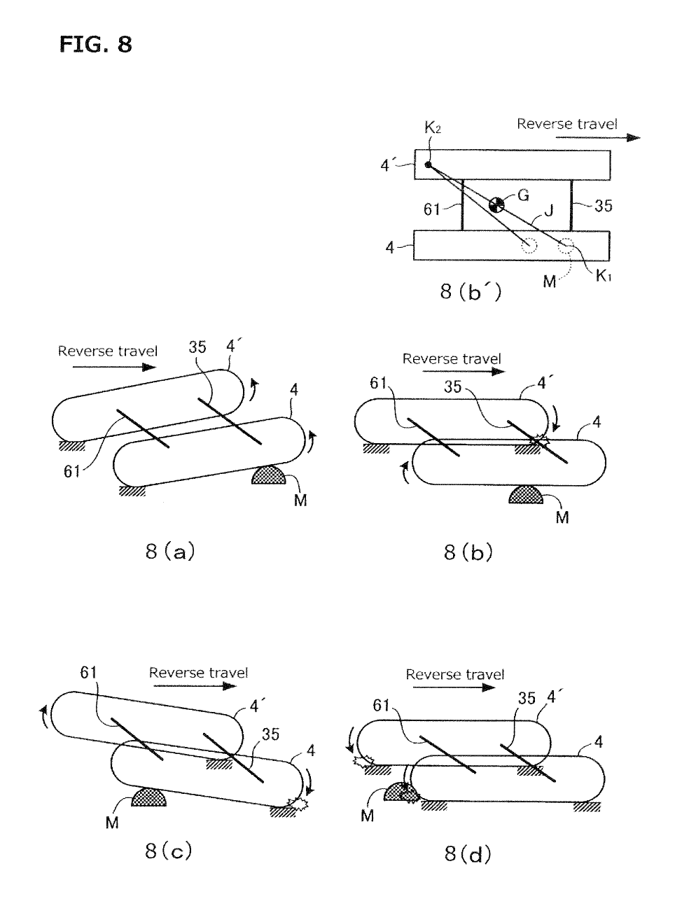

Reference is made to FIG. 8 to describe the behavior when the left undercarriage 4 climbs over the obstacle M with the equalizer bar 61 being locked, for example, in the course of reverse travel.

(See FIG. 8(a))

If the left undercarriage 4 hits against the obstacle M during the nonoperational traveling of the bulldozer 1, the left undercarriage 4 receives an upward thrust load from the obstacle M. The balancing function of the equalizer bar 61 does not work because the equalizer bar 61 is locked. Therefore, the rear parts of the left undercarriage 4 and the right undercarriage 4′ are lifted up together from the ground as shown in FIG. 8(a).

(See FIGS. 8(b) and 8(b′))

Note that Point K₁ is the point at which the left undercarriage 4 is in contact with the obstacle M whereas Point K₂ is the point at which the front part of the right undercarriage 4′ is in contact with the ground. As the bulldozer 1 travels backward, Line J connecting Point K₁ and Point K₂ is shifted forward i.e., in a direction opposed to the traveling direction, as shown in FIG. 8(b′). At the moment when Line J has passed the center of gravity G of the bulldozer 1, the rear part of the right undercarriage 4′ drops onto the ground as shown in FIG. 8(b). At the same time, the front part of the left undercarriage 4 is lifted up from the ground.

(See FIG. 8(c))

After the bulldozer 1 further travels backward, the rear part of the left undercarriage 4 drops onto the ground as shown in FIG. 8(c). During the period after this time point and before the left undercarriage 4 completely rides over the obstacle M, the bulldozer 1 travels backward with the rear parts of both the undercarriages 4, 4′ being in contact with the ground whereas the front parts thereof are lifted from the ground.

(See FIG. 8(d))

At the moment when the left undercarriage 4 completely rides over the obstacle M, the front parts of both the undercarriages 4, 4, which have been lifted up until that moment, drop onto the ground as shown in FIG. 8(d).

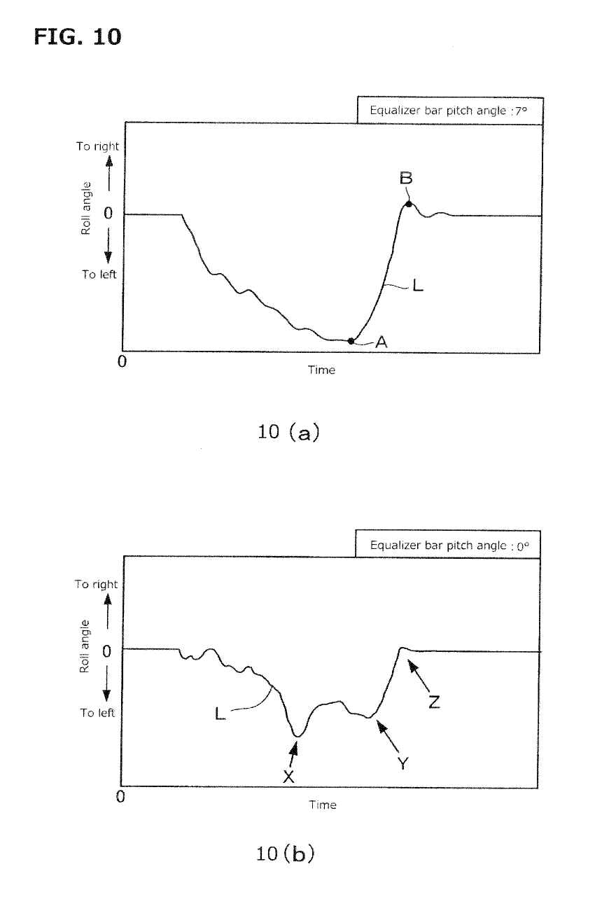

FIG. 10(a) shows the changes in the roll angle of the bulldozer 1 when the maximum pitch angle of the equalizer bar 61 is 7°.

FIG. 10(b) shows the changes in the roll angle of the bulldozer 1 when the maximum pitch angle of the equalizer bar 61 is 0°.

Note that the graphs of FIGS. 10(a) and 10(b) show the changes in the roll angle when the left undercarriage 4 climbs over the obstacle M during the reverse travel of the bulldozer 1. In the graphs of FIGS. 10(a), 10(b), the abscissa represents time. In FIGS. 10(a), 10(b), the positive values on the ordinate represent the roll angle caused by counterclockwise rotation whereas the negative values represent the roll angle caused by clockwise rotation when viewed from the rear side of the vehicle. More specifically, this indicates that when the roll angle has a positive value, the right side of the vehicle is lifted up and when the roll angle has a negative value, the left side of the vehicle is lifted up.

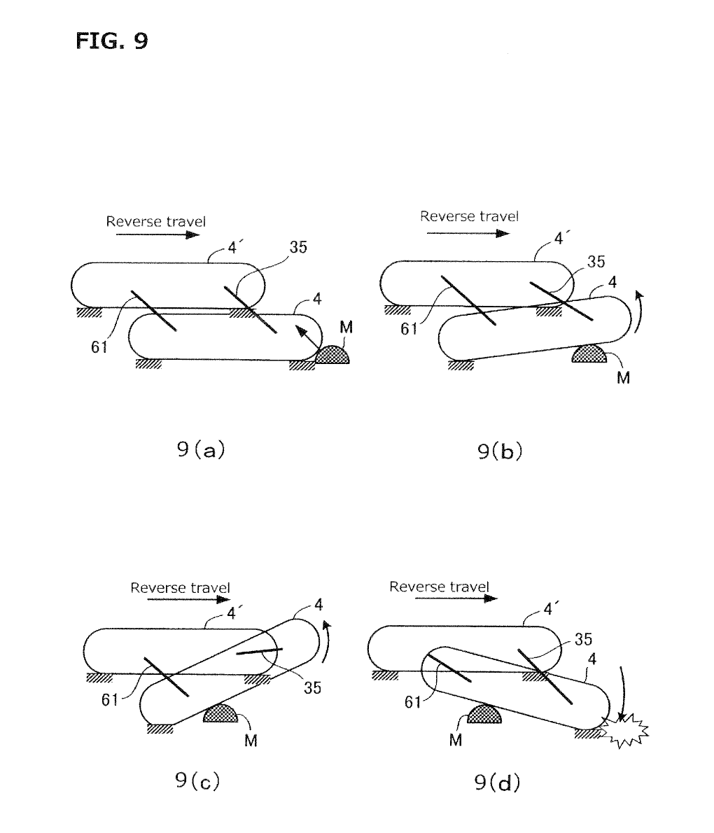

When the left undercarriage 4 rides over the obstacle M with the maximum pitch angle of the equalizer bar 61 being 7° during reverse travel, the left undercarriage 4 is once lifted up high from the ground and then dropped at a breath (see FIGS. 9(b) to 9(d)).

When the maximum pitch angle of the equalizer bar 61 is 7°, the operator receives, at a time, the drop impact caused by the left undercarriage 4 riding over the obstacle M, as indicated by the segment between Points A and B of Line L in FIG. 10(a), Therefore, the impact occurring during the drop is significant and the ride quality is poor during nonoperational traveling.

When the left undercarriage 4 runs over the obstacle M with the equalizer bar 61 being locked and the maximum pitch angle being 0° during reverse travel, the rear parts of the undercarriages 4, 4′ are both lifted up at the same time from the ground (see FIG. 8(a)). Thereafter, the rear parts of the undercarriages 4, 4′ drop onto the ground one after the other (see FIGS. 8(b) to 8(c)) and, subsequently, the front parts of the undercarriages 4, 4′ land on the ground (see FIG. 8(d)).

When the maximum pitch angle of the equalizer bar is 0°, the drop impact caused by the left undercarriage 4 riding over the obstacle M is received in a plurality of occasions, as indicated by Allows X, Y, Z on Line L in FIG. 10(b). The maximum value of the roll angle is small compared to the maximum value when the maximum pitch angle is 7°.

In this embodiment, if it is determined that nonoperational traveling such as on-site movement on uneven terrain is performed (“Yes” at both Steps S2, S3), and it is determined that side slipping is unlikely to occur (“Yes” at Step S4), the equalizer bar 61 is locked by the expansion of the pitch angle change cylinders 65 (see FIG. 4(c)) and the maximum pitch angle of the equalizer bar becomes 0° (Step S5). With this arrangement, the drop impact caused by either one of the undercarriages 4 which is riding over the obstacle M is not received at one time but can be received in a plurality of occasions as indicated by Allows X, Y, Z of FIG. 10(b). Additionally, the drop height itself is small. Therefore, the ride quality of this embodiment during nonoperational traveling can be remarkably improved over that of the prior art.

In this embodiment, if it is determined that nonoperational traveling is performed (“Yes” at both Steps S2, S3) and that there is a small likelihood that side slipping may occur (“No” at Step S4 and “Yes” at Step S6), the amount of projection of the cylinder rods 65a of the pitch angle change cylinders 65 is set to T₁ (see FIG. 4(b)) and the maximum pitch angle of the equalizer bar 61 is set to θ_{B} (4° in this embodiment) (Step S7). This makes it possible to ensure ride quality improved over the prior art during nonoperational traveling and to unfailingly avoid side slipping during traveling on a slope.

In this embodiment, if it is determined that operational traveling such as digging operation on uneven terrain is performed (“No” at Step S2 or Step S3) or that side slipping is highly likely to occur (“No” at Step S6), the amount of projection of the cylinder rods 65a of the pitch angle change cylinders 65 is set to zero (see FIG. 4(a)), and the maximum pitch angle of the equalizer bar 61 is set to θ_{A} (7° in this embodiment) (Step S8). With this arrangement, even if either one of the undercarriages 4 is lifted up from the ground when running over the obstacle M, the contact condition of the other undercarriage 4′ can be kept in a good condition thanks to the balancing function of the equalizer bar 61. Therefore, stable driving power can be ensured even when the vehicle climbs over the obstacle M during digging operation on uneven terrain so that stable digging operation on uneven terrain can be ensured. In addition, occurrence of side slipping can be restricted during traveling on a slope.

Although the suspension device for a work vehicle of the invention has been described according to one embodiment thereof, the invention is not necessarily limited to the particular configuration discussed in the embodiment shown herein and various changes and modifications can be made to the configuration without departing from the spirit and scope of the invention.

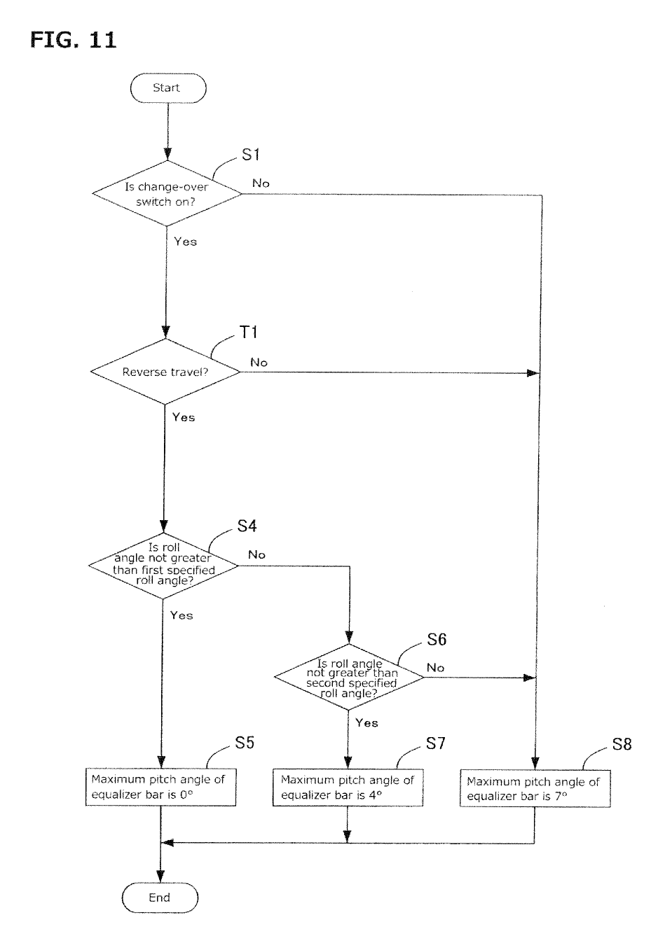

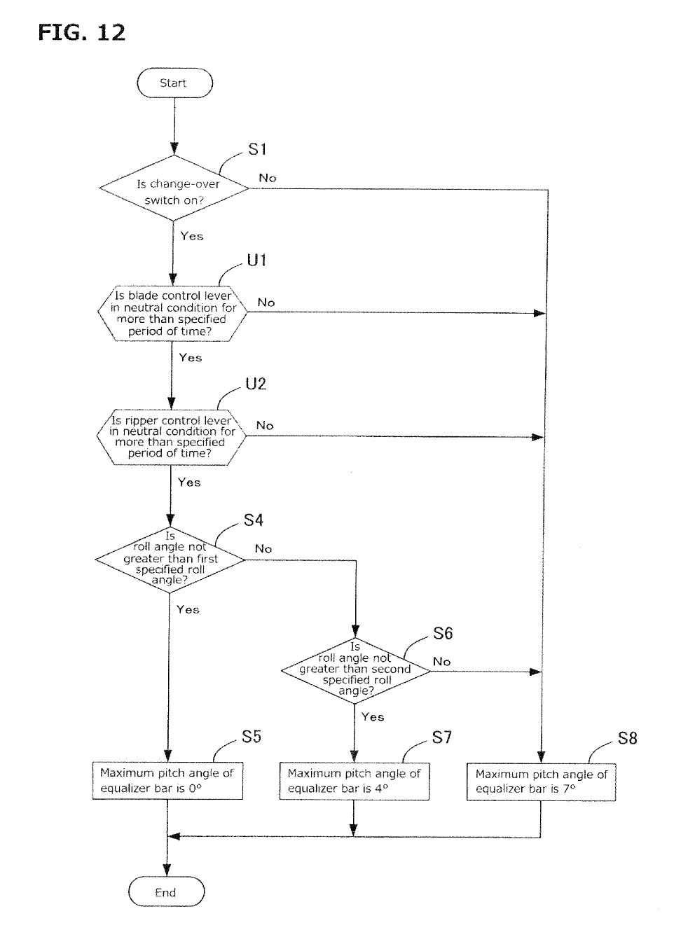

For example, the logic of the maximum pitch angle change program for the equalizer bar 61 shown in the flow chart of FIG. 7 may be replaced with the logic of the maximum pitch angle change program for the equalizer bar 61 shown in the flow chart of FIG. 11 or FIG. 12. In the flow charts of FIGS. 11 and 12, like processing steps are designated by like reference codes employed in FIG. 7. A detailed description of FIGS. 11 and 12 is omitted herein.

In the logic shown in the flow chart of FIG. 7, the height of the blade 40 and the height of the ripper 50 are used as information for making a determination on whether or not digging operation is performed (see Steps S2, S3).

On the other hand, the logic shown in the flow chart of FIG. 11 is designed as follows. Based on the premise that digging operation is not performed during reverse travel but performed during forward travel, a determination on whether or not digging operation is performed is made by determining at Step T1 whether reverse travel is performed, based on a detection signal from the lever operation detector 75a provided for the travel control lever 75.

The logic shown in the flow chart of FIG. 12 is as follows. If it is determined at Step U1 based on a detection signal from the lever operation detector 73a provided for the blade control lever 73 that the blade control lever 73 is not operated for more than a specified period of time (e.g., 2 seconds), that is, the blade control lever 73 is kept in a neutral position for more than the specified period of time, it is then determined that the digging operation by the blade 40 is not performed.

If it is determined at Step U2 based on a detection signal from the lever operation detector 74a provided for the ripper control lever 74 that the ripper control lever 74 is not operated for more than a specified period of time (e.g., 2 seconds), that is, the ripper control lever 74 is kept in a neutral position for more than the specified period of time, it is then determined that the digging operation by the ripper 50 is not performed.

In the foregoing embodiment, the pitch angle change cylinders 65 correspond to the “maximum pitch angle changing means” of the invention. The vehicle body controller 71 corresponds to the “determining means” and “controller means” of the invention.

### INDUSTRIAL APPLICABILITY

The suspension device for a work vehicle of the invention is capable of not only providing improved ride quality during nonoperational traveling such as on-site movement on uneven terrain, but also ensuring stable driving power during operational traveling such as digging operation on uneven terrain. Therefore, it can be well suited for use as a suspension device for a bulldozer.

### REFERENCE NUMERALS

1: bulldozer (work vehicle)

3: vehicle body

4, 4′: undercarriage

20: vehicle body frame

30: track frame

60: suspension device

61: equalizer bar

65: pitch angle change cylinders (pitch angle changing means)

71: vehicle body controller (determining means, controller means)

73: blade control lever

74: ripper control lever

75: travel control lever

73a, 74a, 75a: lever operation detector

77: engine rotational speed sensor

79: tilt angle sensor

1. A suspension device for a work vehicle, having an equalizer bar for coupling undercarriages provided on both sides, respectively, of a vehicle body, the equalizer bar being axially supported by a horizontal pivotal axis so as to be freely swingable, said device comprising:
a maximum pitch angle changing mechanism which changes a maximum pitch angle of said equalizer bar;
a determining device which determines whether or not an excavation operation is performed; and
a controller which controls said maximum pitch angle changing mechanism based on a result of the determination made by said determining device.

2. The suspension device for a work vehicle according to claim 1, wherein said vehicle body has right and left beams which are hollow in section and which are laterally aligned with a specified spacing therebetween, extending in a front-back direction, and wherein said maximum pitch angle changing mechanism comprises hydraulic cylinders provided within said beams respectively.

3. (canceled)

4. The suspension device for a work vehicle according to claim 1, further comprising a tilt angle sensor for detecting a roll angle of the vehicle,
wherein said controller controls said maximum pitch angle changing mechanism based on a result of the detection made by said tilt angle sensor, if said determining device determines that the excavation operation is not performed.
